(19) United States
(12) Patent Application Publication
(10) Pub. No.: US 2008/0295079 A1
(43) Pub. Date: Nov. 27, 2008

(54) System and Method for Verifying and Testing System Requirements

(75) Inventors: Peleg Yiftachel, Western Galilee (IL); Dan Goldwasser, Haifa (IL); Yuval Rapaport-Rom, Haifa (IL)

Correspondence Address: DARBY & DARBY P.C., P.O. BOX 770, Church Street Station, New York, NY, 10008-0770, US

(73) Assignee: P.R.E-POZITIVE REQUIREMENTS ENGINEERING LTD., HAIFA (IL)

(21) Appl. No.: 10/595,553

(22) PCT Filed: Oct. 28, 2004
(86) PCT No.: PCT/IL04/00990

§ 371 Date: Jul. 20, 2006

Related U.S. Application Data
(60) Provisional application No. 60/515,438, filed on Oct. 30, 2003.

(51) Int. Cl. G06F 9/44

(52) U.S. Cl. 717/126

(57) ABSTRACT

There is provided in accordance with embodiments of the present invention a method and a system for testing and verifying a requirements specification of a system comprising describing the requirements specification in a REQUIREMENTS ENGINEERING LANGUAGE (REL), simulating an execution of a scenario of the REL, and identifying logical faults in said requirements specification based on said simulating. Accordingly, the system for testing and verifying of requirements specification of a system comprising a modeling and testing component to build a model of the requirements specification, and a dynamic testing component to test the requirements specification by execution of at least one simulation cycle.

### FIELD OF THE INVENTION

The present invention relates in general to a system and method for verifying and testing system requirements. More particularly, the present invention relates to a system and method for writing system specifications and verifying the specifications by simulation.

### BACKGROUND OF THE INVENTION

Software development is a process typically made of several phases. First, system requirements are gathered and analyzed. This is known as the Requirements phase. Next, in the Design phase, system requirements are transformed into design. Then, during the Implementation phase, the design is built or programmed into the actual system. The system is tested against the original requirements during the Testing phase. The last phase is typically known as Operation and Maintenance. In this phase the system is installed and maintained at a customer site.

Specifying system requirements is an essential phase of every system development process, as all following stages of development depend on the correct capturing and understanding of the system during the Requirements phase. Accordingly, errors or faults that are left unnoticed at this phase may cause wrong decisions at later phases, resulting in systems that either miss customers' needs or are littered with malfunctions, known as “bugs”. Such bugs may occur because the specified system requirements were incoherent, inconsistent, incomplete or ambiguous.

Research shows that the cost of fixing a bug at the Requirements phase grows exponentially if the bug is caught later in the development process.

The importance of accurate and complete specification of system requirements has prompted much research focusing on improving current methods.

One approach of modeling systems is by the use of Abstract Machines. An Abstract Machine is described as using the Abstract Machine Notation (AMN). AMN is a state-based formal specification language, using a collection of mathematically based techniques for system requirements specification. An Abstract Machine typically comprises a state together with operations on that state. In a specification and a design of an Abstract Machine the state is modeled using notions like sets, relations, functions, sequences etc. The operations are modeled using pre and post-conditions using AMN. The method prescribes how to check the specification for consistency (preservation of invariant) and how to check designs and implementations for correctness (correctness of data refinement and correctness of algorithmic refinement). An example of the use of AMN may be found in the B-Method, developed by B-Core. The B-Method, however, does not perform ambiguity checks, completeness checks, or temporal invariant preservation.

Using languages for expressing structured, declarative system models, and automatically analyzing properties of those models, using first order logic, is another approach. The formal specification notation Z, useful for describing computer-based systems, is based on Zermelo-Fraenkel set theory and first order predicate logic. It has been developed by the Programming Research Group (PRG) at the Oxford University Computing Laboratory (OUCL) and elsewhere since the late 1970s.

Based on models written in formal languages such as Z, tools that support such languages can generate instances of invariants, simulate the execution of operations (even those defined implicitly), and check user-specified properties of a model. The Alloy language, emanating from Z, was developed by the Software Design Group at the MIT Laboratory for Computer Science, is an example of such a language. The Alloy Analyzer is a tool for analyzing models written in Alloy. Alloy and its analyzer have been used primarily to explore abstract software designs. Alloy therefore focuses on the Design and Implementation stages of the development process, rather than on requirements engineering. Moreover, it lacks the ability to verify temporal invariants.

ZANS is an animation tool for Z specifications. ZANS was developed by a software engineering group at the School of Computer Science, Telecommunications and Information System at the DePaul University. The main goals of ZANS are: to facilitate validation of Z specifications; to experiment design refinement and code synthesis based on Z specifications. Currently, it supports the following features: type checking of Z specifications; expansion of schema expressions; evaluation of expressions and predicates; execution of operation schemas. ZANS does not perform ambiguity checks, completeness checks, or temporal invariant preservation.

Z/EVES uses state-of-the-art formal methods techniques, integrating a specification notation with an automated deduction capability. The resulting system supports the analysis of Z specifications in several ways: syntax and type checking, schema expansion, precondition calculation, domain checking, and general theorem proving. The Z/EVES methods were developed by ORA Canada. Z/EVES does not perform ambiguity checks, completeness checks, or temporal invariant preservation.

The Unified Modeling Language (UML), developed by the Object Management Group (OMG), represents yet another approach. The UML comprises of 13 diagrams that capture different views of a system, during its early requirements and design phases of development. The Use Case diagram is used for specifying system requirements. Robustness diagrams, a part of the Agile Modeling methodology developed by Scott W. Ambler, extend Use Cases. The basic idea of Robustness diagrams is to analyze the steps of a Use Case in order to validate the business logic within it and to ensure that the terminology is consistent with other Use Cases that users have previously analyzed. In other words, users can ensure that their Use Cases are sufficiently robust to represent the usage requirements for the system they are building. Another use of Robustness diagrams is to identify potential objects or object responsibilities to support the logic called out in the use case, effectively acting as a bridge to UML diagrams such as Sequence Diagrams and Class Diagrams. Robustness diagrams do not incorporate the ability to define invariants and properties, and thus any tool supporting Robustness Diagrams will inherently lack the ability to verify the preservation of such invariants.

The ASM thesis is that any algorithm can be modeled at its natural abstraction level by an appropriate ASM. Based upon this thesis, members of the ASM community have sought to develop a methodology based upon mathematics which would allow algorithms to be modeled naturally; that is, described at their natural abstraction levels. The ASM methodology aims at being able to describe the entire software life-cycle: requirements specification, design and implementation. It goes further to state that it will enable users throughout the process to validate their work against the ASM model. The ASM does not incorporate the ability to define temporal invariants, and therefore tools supporting ASM are not able to perform temporal invariant preservation tests.

### SUMMARY OF THE INVENTION

There is provided in accordance with embodiments of the present invention a method for testing and verifying a requirements specification of a system comprising describing the requirements specification in a REQUIREMENTS ENGINEERING LANGUAGE (REL), simulating an execution of a scenario of the REL, and identifying logical faults in the requirements specification based on the simulating.

There is further provided in accordance with embodiments of the present invention a system for testing and verifying of requirements specification of a system comprising a modeling and testing component to build a model of the requirements specification, and a dynamic testing component to test the requirements specification by execution of at least one simulation cycle.

There is further provided in accordance with embodiments of the present invention a modeling and testing apparatus comprising a moderator component to translate a high-level specification requirements to a requirements engineering language, an object builder component to build a unique representation of the specification requirements, and a checker component to check characteristics of the unique representation.

There is further provided in accordance with embodiments of the present invention a dynamic testing apparatus comprising a requirements tests manager to define, simulate, and analyze a scenario, a simulator manager to coordinate the simulation sequence of the scenario, a dynamic verification manager to activate the checkers during the simulation sequence, and a simulation and verification manager to control the dynamic testing component.

### BRIEF DESCRIPTION OF THE DRAWINGS

The present invention will be understood and appreciated more fully from the following detailed description taken in conjunction with the appended drawings in which:

FIG. 1 is a schematic diagram of the structure of requirements engineering language (REL) entities in accordance with some embodiments of the present invention;

FIG. 2 is a schematic diagram of the syntactic structure of REL entities in accordance with some embodiments of the present invention

FIG. 3 is a schematic diagram of the syntax elements of REL in accordance with some embodiments of the present invention

FIG. 4 is a schematic block diagram of an exemplary liquid container system to demonstrate exemplary embodiments of the present invention;

FIG. 5 is a block diagram of an exemplary component entity in accordance with some embodiments of the present invention;

FIG. 6 is a block diagram of an exemplary data entity in accordance with some embodiments of the present invention;

FIG. 7 is a block diagram of a second exemplary data entity in accordance with some embodiments of the present invention;

FIG. 8 is a block diagram of an exemplary type entity in accordance with some embodiments of the present invention;

FIG. 9 is a simplified graph of the REL temporal semantics in accordance with some embodiments of the present invention;

FIG. 10 is a block diagram of an exemplary operation entity in accordance with some embodiments of the present invention;

FIG. 10A is a schematic translation of the syntax provided in FIG. 10;

FIG. 10B is a simplified graph describing the exemplary operation entity of FIG. 10;

FIG. 11 is a block diagram of a second exemplary operation entity in accordance with some embodiments of the present invention;

FIG. 11A is a schematic translation of the syntax provided in FIG. 11;

FIG. 11B is a simplified graph describing the exemplary operation entity of FIG. 11;

FIG. 12 is a block diagram of a third exemplary operation entity in accordance with some embodiments of the present invention;

FIG. 12A is a schematic translation of the syntax provided in FIG. 12;

FIG. 12B is a simplified graph describing the exemplary operation entity of FIG. 12;

FIG. 13 is a block diagram of a fourth exemplary operation entity in accordance with some embodiments of the present invention;

FIG. 13A is a schematic translation of the syntax provided in FIG. 13;

FIG. 13B is a simplified graph describing the exemplary operation entity of FIG. 13;

FIG. 14 is a block diagram of a fifth exemplary operation entity in accordance with some embodiments of the present invention;

FIG. 14A is a schematic translation of the syntax provided in FIG. 14;

FIG. 14B is a simplified graph describing the exemplary operation entity of FIG. 14;

FIG. 15 is a block diagram of an exemplary temporal logic property entity in accordance with some embodiments of the present invention;

FIG. 15A is a schematic translation of the syntax of the temporal formula provided in FIG. 15

FIG. 15B is a simplified graph describing the exemplary temporal logic property entity of FIG. 15;

FIG. 16 is a block diagram of an exemplary scenario execution entity demonstrating an inconsistency error in accordance with some embodiments of the present invention;

FIG. 16A is a simplified graph describing the exemplary scenario execution entity;

FIG. 17 is a block diagram of a second exemplary scenario execution entity demonstrating an incompleteness error and an invariant failure in accordance with some embodiments of the present invention;

FIG. 17A is a simplified graph describing the exemplary scenario execution entity;

FIG. 18 is a block diagram of a third exemplary scenario execution entity demonstrating a temporal invariant failure, a failure of the type restrictions, and a non-deterministic error in accordance with some embodiments of the present invention;

FIG. 18A is a simplified graph describing the exemplary scenario execution entity;

FIG. 19 is a simplified Venn diagram depicting the expressiveness of REL language and verification abilities with respect to a given model.

FIG. 20 is a schematic block diagram of an exemplary system for testing and verification of system specifications requirements in accordance with some embodiments of the present invention;

FIG. 21 is a schematic block diagram of an exemplary Requirements Static Modeling and Testing Component in accordance with some embodiments of the present invention;

FIG. 22 is a schematic block diagram of an exemplary Requirements Dynamic Testing Component in accordance with some embodiments of the present invention;

FIG. 23 is a schematic block diagram of an exemplary Simulator Manager in accordance with some embodiments of the present invention;

FIG. 24 is a schematic block diagram of an exemplary Object Builder in accordance with some embodiments of the present invention;

FIG. 25 is a flow chart illustration of a method of building a checker, operative in accordance with some embodiments of the present invention;

FIG. 26 is a schematic block diagram of an exemplary Dynamic Verification Manager in accordance with some embodiments of the present invention;

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention.

### DETAILED DESCRIPTION OF THE PRESENT INVENTION

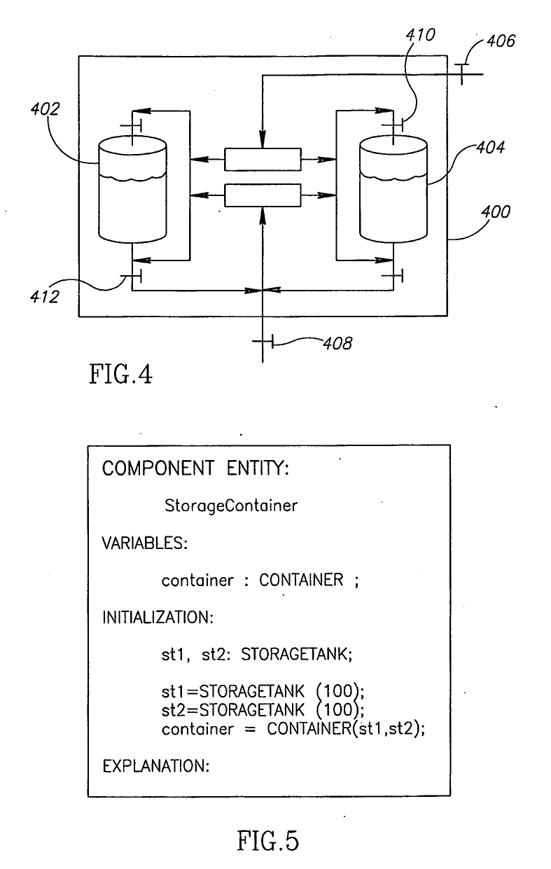

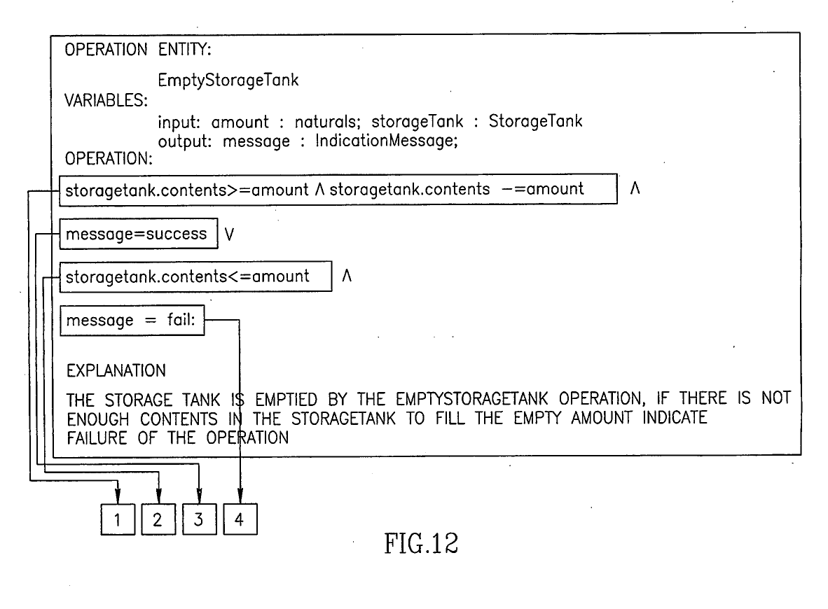

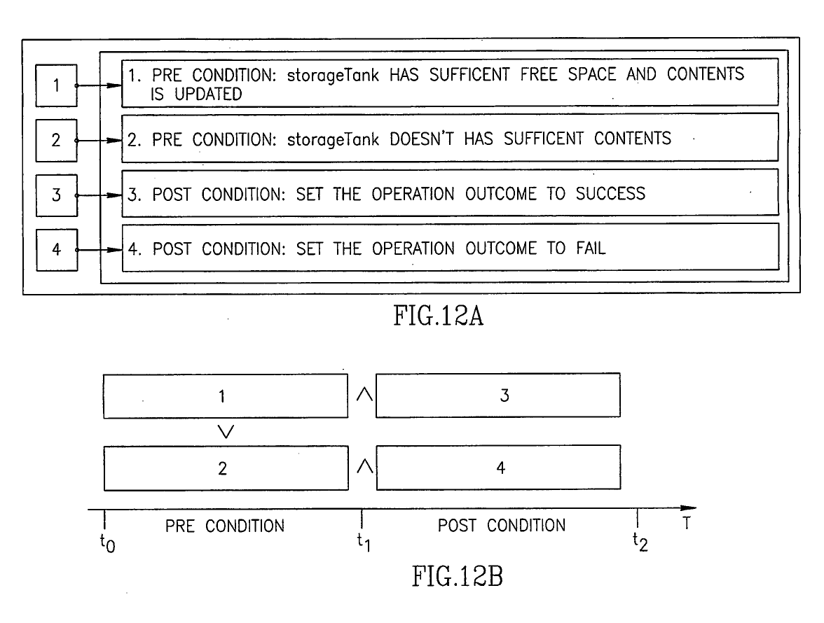

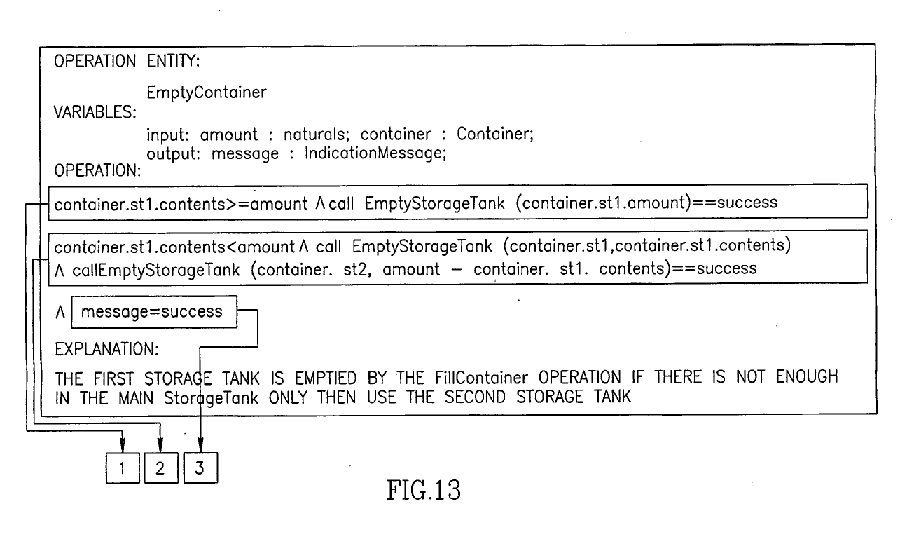

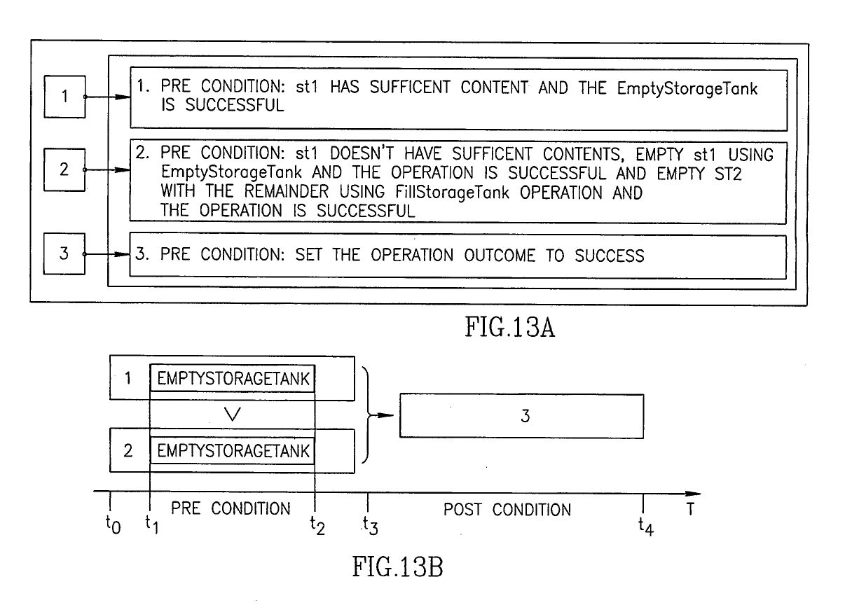

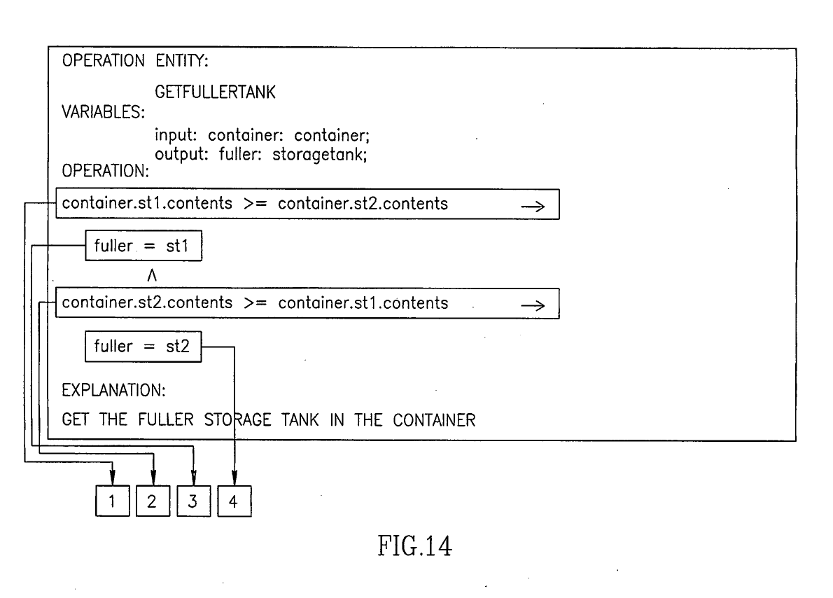

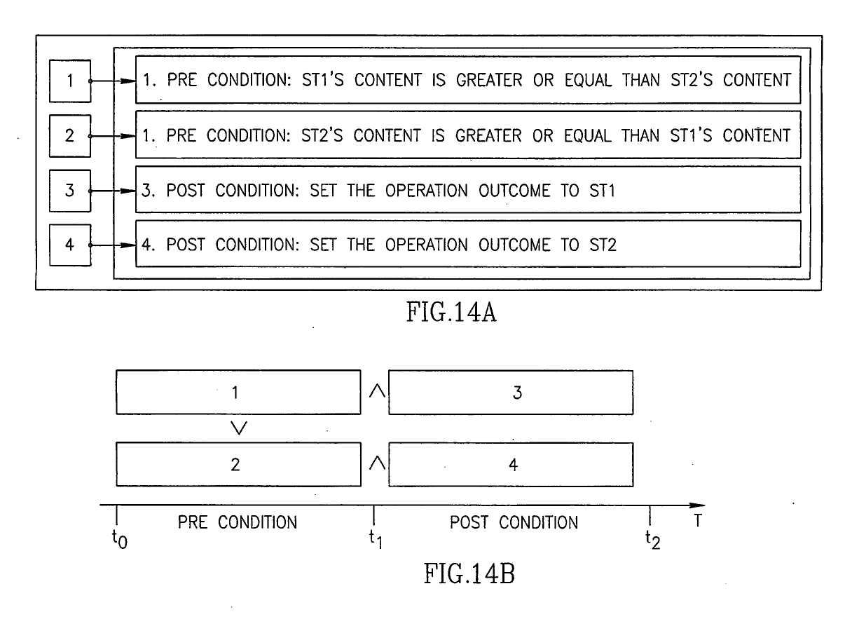

The following detailed description explains in details the embodiments of the present invention. It should be noted that in the example described in the detailed description, also illustrated in FIGS. 4-18A, contains several errors in order to demonstrate the ability of the requirements engineering language (REL) to verify requirements expressed in REL.

### Requirements Engineering Language (REL): Syntactic Elements and Basic Structure

In accordance with some embodiments of the present invention requirements specification expressed in high level specification languages may be verified and tested, thus enabling the user to detect logical mistakes or faults in the specification. The definition of the requirements specification may be expressed using any high-level specification language. High-level specification languages are defined to be graphic languages used for modeling systems, structured languages with well-defined syntax and semantics. The syntax may have a graphical representation. The conversion to REL from the given high-level language may be done by retaining the semantics of the given specification language expressed in REL; Verification of the converted specification may require additional data. The specification may be converted into REL as will be described in details below. REL may differentiate between several aspects of a specified system in order to verify its correctness. Among these aspects are, for example, system-specific type definitions, data entities, operation entities, components entities, temporal logic property entities and scenario execution entities, which will be described in details below. The specified system, in REL format, may be verified statically or dynamically.

Still in accordance with some embodiment of the present invention a simulation of the specified system may be performed in REL format. During the simulation the values of the data entities in the specified system may be changed at each simulation step according to the operation performed.

The REL language may be used directly or, alternatively, it may be translated into from any other high-level specification language. Converting high-level specification language into REL may be done according to the specific semantics of each high-level language. A description of REL and the guidelines according to which the conversion to REL may be done is provided below. It should be noted that a requirement specification of a system may be defined as a description of the services of a system and the constraints imposed on it during its operation.

Requirements specification languages may describe different views and aspects of a system, be it an abstract statement of desired service (sometimes referred to as user requirements) or a detailed description of the specified system behavior and constraints (sometimes referred to as system requirements). The different aspects may reflect the different uses of the requirements stage within the development process. REL may capture the different possible views by separating the specification into several entities, each used for describing the requirements of a corresponding element in the requirement process.

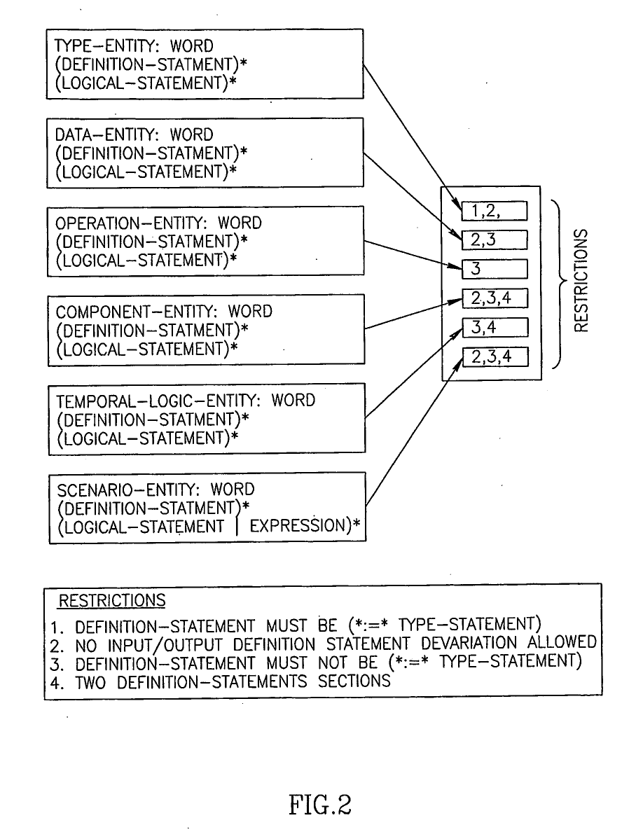

Reference is now made to FIG. 2 which is a schematic diagram of the syntactic structure of the REL entities in accordance with some embodiments of the present invention. REL may contain the following entities:

Type entities may enable the user to define, for example, specification specific variables types, their range of values and constraints on the variables of that type.

Data entities may contain variables and their values; a data entity may also contain constraint on its variables.

Operation entities may contain variables, some of which may be input variables, and a definition on how the variables may be manipulated during the simulation. The manipulation of variables may take place either sequentially or in parallel, and may contain, for example, a description of the pre-condition which must exist for the post-condition to take place.

Component entities may give, for example, an exact definition of the specified system scope, its interfaces and users, and may provide a starting point for the simulation of the specified system. The component entity may be considered to be the specified system, and the output file describing the change in the system states throughout the simulation may contain a snapshot of the component entity variables.

Temporal Logic entities may contain temporal restrictions imposed on the system. The temporal logic entity may consist of two parts. The first part may be the definition of Boolean events in the system. Boolean events may be expressed using first ordered logic. The second part of a temporal logic entity may be the definition of temporal logic formulas using the Boolean events as Boolean atoms of the formula. Temporal logic formula may capture the behavior of the specified system over a period of several simulation cycles.

Scenario execution entitles may contain an execution scenario of the system. The simulation of the specification may be done according to the scenario entities. The scenario entities may be used for the purpose of testing the requirements specification.

The ability of REL to capture views of a specification may be better understood in the following example. User requirements may be expressed by the specification of a component entity, which may contain the description of the high-level data entities of the system, and services supplied by the system to its users. System requirements may be expressed by decomposing high-level requirements expressed by the component entity into smaller sub-systems, using data entities to define sub-systems and the restrictions imposed on them, type and operation entities may be used to describe interfaces and services provided by sub-systems, and the way sub-systems may interact.

After the specification is modeled in REL, testing of the system specification requirements may commence. During simulation the specification may be checked to be consistent, deterministic and complete. A consistent specification may be a specification in which there are no conflicting requirements. A deterministic specification may be a specification in which on any given operation and data entities values, there may always be no more than a single possible outcome. A complete specification may be a specification in which on any given operation and data entities values, there may always be an outcome; Other definitions of these terms are quite common. Throughout this document the use of these terms will be in regard to the definition given above unless stated otherwise. In addition, during simulation the restrictions defined by the user, both invariants and temporal logic formulas, may be checked at each simulation step.

Verification abilities described above may be achieved by a simulation environment which will be described in details below. Inconsistency, incompleteness and non-determinism, may be checked by the realization of REL semantics. In the circumstance in which these terms occur, the simulation engine may not continue with a straight forward simulation as will be described in details below. The simulation engine may, for example, stop and indicate the existence of such errors or faults. The simulation, however, may continue, should the user opt to do so, by defining a default legal state to which the specification model will be set in case of an error state. A detailed description is provided below.

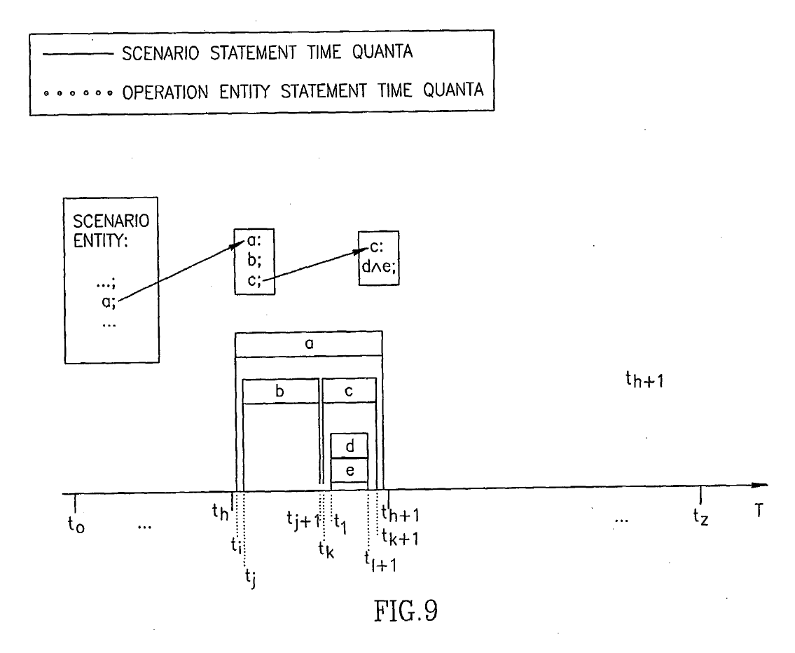

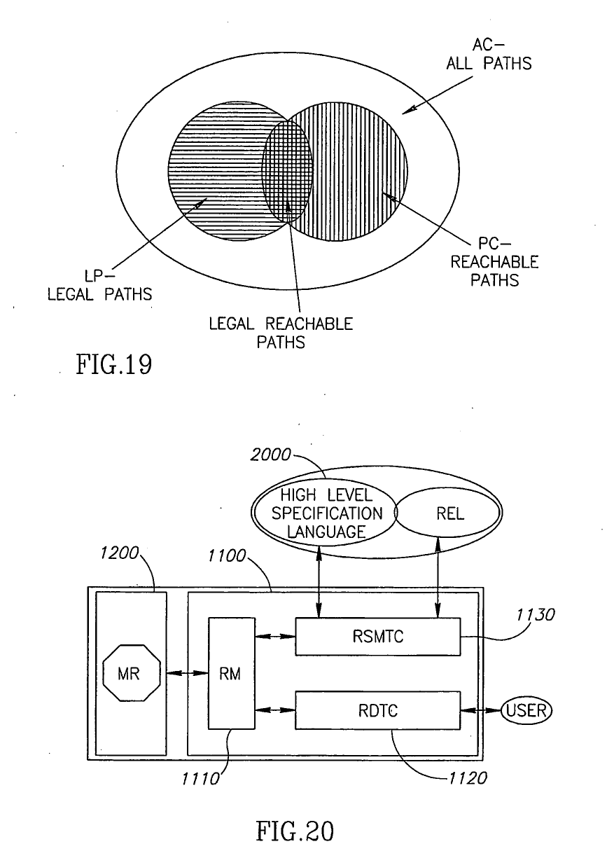

Reference is now made to FIGS. 9 and 19 which describe the semantics of REL. As Shown in FIG. 19, a component entity cmp may define a set of states, as, consisting of all possible states; a state may be defined as a value vector of all the values of all variables defined in cmp. The set as may contain all possible permutations on the values of that vector. The component entity cmp may further be defined as a set of computation paths, ap, such that all sequences of states belonging to as, may belong to ap. A path in ap may be finite or not. The component entity cmp may further be defined as a specification model sm, consisting of the set of all legal states, is. A state may be considered legal if all invariants hold in that state. sm may also contain the set of all legal computation paths, lp. A path may be considered legal if it contains only legal states and all temporal invariants hold on that path. All paths in lp may start from the start state defined by the initialization list in cmp. The start state may be assumed to be a legal state as cmp contains it, and could not be created with an illegal start state. A set of operation entities, oes, defined over cmp, may be defined as a set of all possible computation paths, pc. All possible permutations of applying the members of oes, starting from the start state, defined by cmp initialization list, may be members of pc. oes may also define a set of states, ps, consisting of all states belonging to any of the paths in pc that are members of ps. A specification consisting of cmp, its relevant type entities, data entities, temporal logic entities and oes, is legal if pc⊂lp and ps⊂ls, and for every member of oes, does not exist a state sᵢ such that when an operation schema os is used as the transition function for sᵢ₊₁ the next state, sᵢ₊₁ is not defined. REL semantics under simulation are defined in FIG. 9 which depicts a scenario execution entity se containing l logical statements. se may define a simulation s on sm, spanning over l simulation cycles. The simulation s may begin with the first statement in se and may end with the final logical statement in se. Each logical statement in se may define a simulation cycle. Simulation time T may be defined to be the time in which the simulation may take place; T may be measured in units corresponding to a simulation cycle; for any given simulation cycle i s.t. 0=<i<f, f being the number of logical statements in se, the simulation cycle may be completed within a time tᵢ and tᵢ₊₁. All logical terms (predicates) within that time frame may be checked in parallel within that simulation cycle. If the statement contains any invocation calls for other operation entities, these entities may be executed within that time frame, and take place at a fraction of the time (tᵢ₊₁−tᵢ). A specification model state may be defined to be the values of all variables in the specification model at a given point. Each invocation call of an operation entity, regardless of the nesting depth of the call during execution, may create a sequence of states of that given simulation time, although partial to the scenario execution entity simulation cycle. REL time model may be discrete as specifications may be finite and within a finite length specification only a finite number of nested operation entity invocation calls may be possible. For example consider the following, depicted in FIG. 9:

Let a be an operation entity and let st be a logical statement in a scenario execution entity se, such that st is the h-th logical statement in se and st contains an invocation call to a. Let a contain two logical statements containing invocation calls to operation entities b and c respectively. Let c contain a single logical statement consisting of invocation calls to operation entities d and e. The scenario statement st in se will be simulated at h until h+1 simulation cycles. These cycles may take place at Simulation Time tₕ until tₕ₊₁. Within that time span a may be simulated in simulation time tᵢ until tᵢ₊₁ such that tᵢ>tₕ and tᵢ₊₁<tₕ₊₁. The Operation entity a may contain two sequential invocation calls to operation entities b and c. These will start at simulation time tⱼ and tₖ and end at simulation cycle tⱼ₊₁ tₖ₊₁ respectively, such that tⱼ<tⱼ₊₁<tₖ<tₖ₊₁. The operation entity c may contain a single logical statement invoking the operation entities d and e in parallel using a logical connective; both d and e will be executed between tₗ and tₗ₊₁.

As described above, REL may be composed of several entities, capturing different views and aspects of the requirements model. The entities may be composed of several syntactic elements, for example, definition elements and logical statement elements. Each of the syntactic elements may have a different interpretation, depending on the wrapping entity in which it is defined. For example, a logical statement syntactic element defined in a data entity may have a different interpretation of logical statement defined in an operation entity.

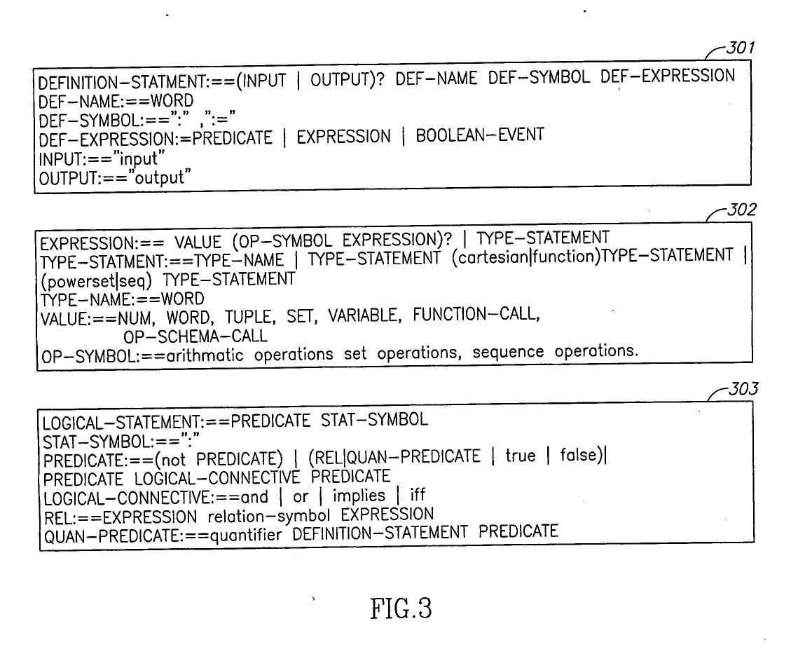

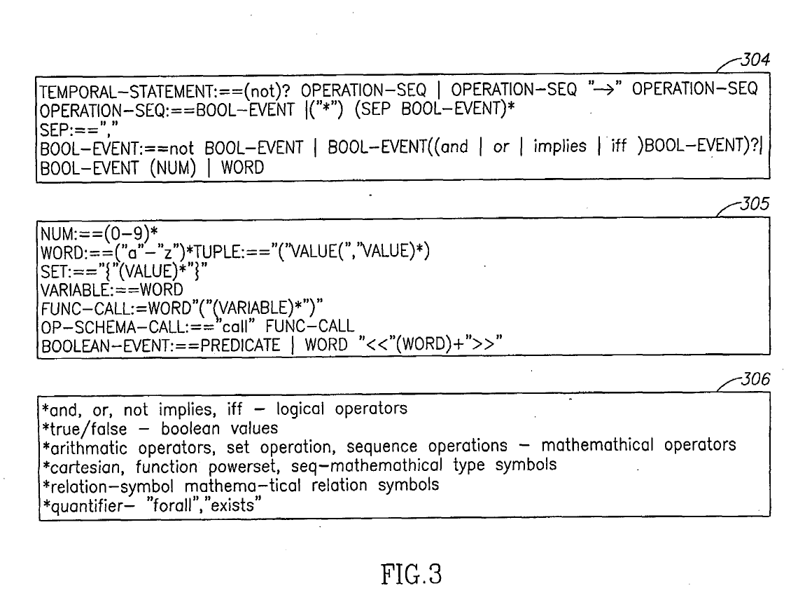

Reference is now made to FIG. 3 which is a schematic diagram of the syntax elements of the requirements engineering language (REL) in accordance with some embodiments of the present invention.

A definition statement 301 may be used for the definition of variables, types or events. An example of a definition statement may be:
x: Integers

An expression 302 may be characterized as having a value. An example of an expression may be a number, a variable, arithmetic expression or set-theory expression, a tuple and the like.

A predicate may be defined to be a logical expression which can be assigned a Boolean value. Predicate may be, for example, a simple true/false expression, a relation (which may sometimes be referred to as atomic formulas), a predicate composed of atomic formulas connected with logical connectives or quantified predicates.

A logical statement 303 may be characterized as a predicate defined in regard to a simulation cycle; a statement holds true at a given cycle. A list of logical statements is a list of expressions which can be evaluated to be true or false at a sequence of simulation cycles. For example, the statement x=10; may be true or false in a simulation cycle whereas x!=10; y!=5; are two statements each having a Boolean value in two consecutive simulation cycles.

A temporal statement 304 may be a logical statement expressing a temporal constraint. The constraint may hold a true value under a simulation. An example of a temporal statement may be:
NOT {(*), req, wait(2)}
   wait and req are Boolean events defined in a Temporal Logic Entity and may consist of a logical statement assigned a Boolean value at each given cycle.

The given temporal logic entity expresses the requirement that the following execution scenario should not occur: “sometimes a req is followed by two consecutive wait” The term within the brackets (“{“,”}”) is a temporal formula describing a sequence of states as detailed above, the NOT operator prohibits this sequence.

As described above, REL may be composed of entities, each representing a different view of a specified system. Further details on these entities, their role in a specification, their semantics and temporal semantics under simulation are described in details below. The explanation will be accompanied with an example, demonstrating each of the entities principles. It should be noted that the example contains intentional errors for the explanation of the use of REL verification.

Reference is now made to FIG. 4 which is a schematic block diagram of an exemplary liquid container system 400 to demonstrate the embodiments of the present invention. Liquid container system 400 may include two storage tanks 402 and 404. The container is required to support the following: adding contents 406 and removing contents 408. These operations may be accomplished using the ‘add’ operation 410 and ‘remove’ operation 412 of the storage tanks.

As described above a component entity of REL may give a definition of the specified system scope, Its interfaces and users, and provide a starting point for the simulation of the specified system. The component entity may be considered to be the specified system, and the simulation output may describe the change in system states throughout the simulation, and may contain a snapshot of the component entity variables. The definition statement part of a component may determine the scope of the specified system. The logical statement part of a component entity may handle initialization. The first part of the definition statements may include temporary initialization variables used for the initialization process. The second part of the logical statements may initialize data entity instances. The initialized data entities defined within the scope of the component entity definition statement part scope will be referred to as data objects hereinafter and may be regarded as an instantiation of the data entities.

Referring now the example described in FIGS. 4 and 5 which illustrates the use of a component entity in accordance with some embodiments of the present invention. The component entity of FIG. 5 contains a variable, whose type is Container, which may be defined by a data entity of the same name. As mentioned before, variables may be considered to be instances of data entities. In the initialization part, the first statement declared the use of two initialization variables—st1 and st2 and the following logical statement may initialize the container using these variables. The initialization statement may set both the container's storage tanks to a limit (capacity) of 100.

A data entity may be described as a template for the creation of a data object. A data entity may consist of variables and an optional constraint on the possible values of its variables. The constraint may hold at a given simulation cycle according to the values of the corresponding data object variable at that cycle.

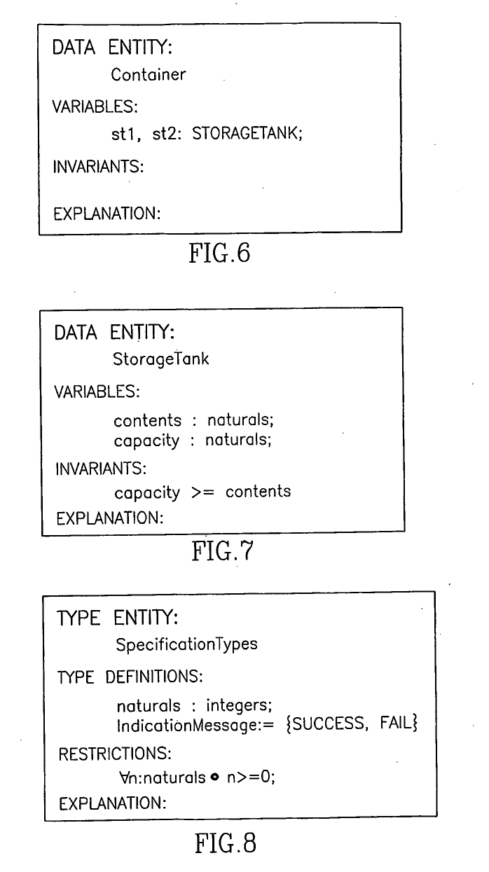

FIG. 6 is a block diagram of a Container data entity in accordance with some embodiments of the present invention. FIG. 7 is a block diagram of a StorageTank data entity in accordance with some embodiments of the present invention. The Container data entity may include two variables, both of the StorageTank type. The StorageTank data entity may include two variables, contents and capacity, both of type called naturals and a constraint asserting that the contents should be less than the capacity at any given simulation cycle. The type of these variables, naturals, may be defined in a type entity as will be described in details below.

A type entity may enable users to define specification specific variable types, their range of values and constraints on the variables of that type. The type definition statement part in a type entity may contain type declarations and the logical statement part may contain restriction on the types defined in the definition statements part. In FIG. 8, IndicationMessage is defined by a set of possible values and naturals is defined to be of type integers with the constraint that the value of all variables of that type should be greater or equal to zero.

It should be noted that the entities described above in FIGS. 5-8 specify the requirements from the data objects of the specified system. The following entities describe how these data objects may be manipulated and verified. Operation entities may describe the requirements from the manipulation of the specified system data objects. Manipulations may consist of a list of logical statements each describing preconditions and post conditions. Operation entities may contain two parts: definition statements and logic statements. Definition statements may define the input variables for the given operation entity and the output of the operation entity. The logic statements part may consist of a description of how the variables should be manipulated. Operation entities may be specified at several granularity levels: as a single logical statement or several logical statements spanning over several simulation cycles. The description of each logical statement may be divided according to possible pre-conditions and their corresponding post conditions. The term pre-condition may indicate a predicate that may receive a Boolean value with respect to the value of variables at the current simulation cycle. A post-condition may be a predicate containing a description of what may hold true value at the next simulation cycle.

Reference is now made to FIG. 9 which is a simplified graph of REL temporal semantics in accordance with some embodiments of the present invention. The graph of FIG. 9 describes the temporal semantic of an operation entity. The starting point of an operation entity is its first logical statement. Each of the statements may be evaluated in consecutive simulation cycles. All predicates within a statement may be done in parallel, meaning that a statement may start at a time tᵢ and be completed at tᵢ₊₁. If a statement contains an invocation request to other operation entities, the invoked operation entity may be completed before tᵢ₊₁, regardless of the amount of statements in the invoked entity. Further description of FIG. 9 will be provided below along with the description of the scenario entities.

Returning now to the example of FIG. 4, there may be four operation entities related to the operations required from the storage tank. FillContainer and EmptyContainer operation entities that may be used to add or remove contents to or from the container, respectively. These may require the use of two additional operation entities: FillStorageTank and EmptyStorageTank.

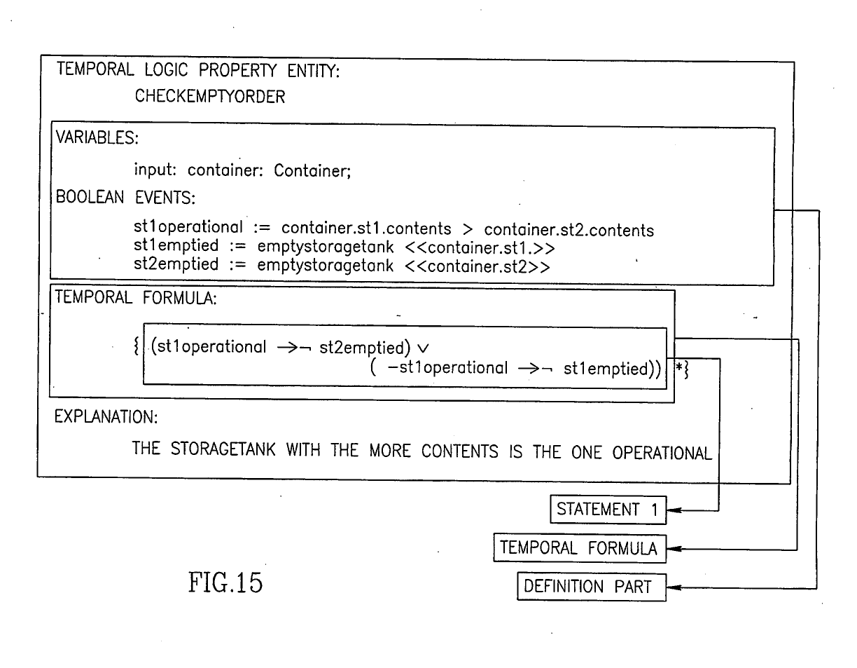

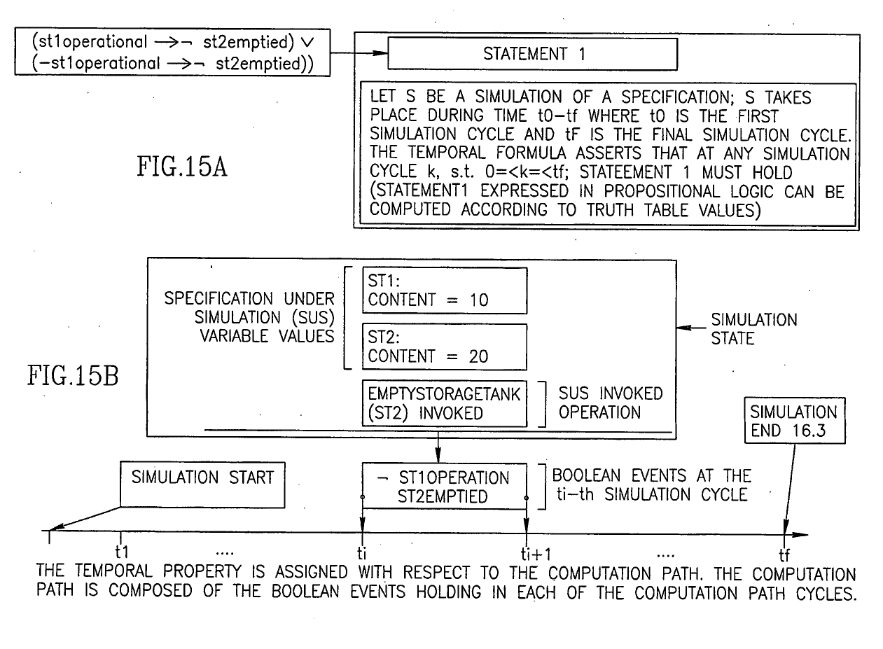

Reference is now made to FIG. 15 which is a block diagram of an exemplary temporal logic property entity in accordance with some embodiments of the present invention. A temporal logic entity may contain temporal restrictions on the behavior of the specified system during simulation. In general, temporal logic entities may contain temporal restrictions imposed on the system. The temporal logic entity may include two parts. The first part may be the definition of Boolean events in the system. Boolean events may be defined as expressing values using first order logic. The second part may be a temporal logic formula capturing the behavior of the specified system over a period of several simulation cycles. The behavior at any given simulation cycle may be specified by using Boolean events.

Boolean events may contain assertions on the state of the specified system during simulation at a given simulation cycle. The Boolean event may be assigned values in regard to the wrapping temporal logic entity input variables.

FIG. 15 describes an exemplary temporal entity. The temporal entity shown in FIG. 15 includes two parts. First, a definition part composed of two parts—an input variable declaration that may be used to bind the temporal logic entity at simulation time to a data object, e.g., a container data object in the example of FIG. 4, and a Boolean events definition. In the example related to FIG. 4 three events may be defined: the first (ST1Operational) may be defined using the variables in the input variable (container) and may be assigned a truth value according to the value of these variables. The other two (ST1Emptied, ST2Emptied) may be defined as using the input variable and the specification under simulation operation entities, e.g., if the specified operation is invoked in the simulation and the specified data object is used as input for the operation, these Boolean events hold true values. The second part of a Temporal logic property is a temporal formula definition that may characterize legal simulation paths. Each simulation path may be composed of simulation cycles and may hold Boolean events in each of the cycles. The temporal formula definition may assert that on a given simulation path, on all simulation cycles the following must hold:
(ST1Operational→ [symbol] ST2Emptied) v
( [symbol] ST1Operational→ [symbol] ST1Emptied));

This proposition may be computed relatively easily using the appropriate truth table. The Boolean events may be assigned according to the state of the simulation.

FIG. 15 describes the logical contents of the temporal logic entity, divided into Definitions, Boolean events and temporal formulas. Note the syntactic convention of WORD1 <WORD2>>, where word1 being an operation entity name, and word2 being a variable name which is used as input to the operation entity. FIG. 15A describes the semantics of the contents of the temporal formula. FIG. 15B describes the time line of execution of the temporal logic property entity in a simulation.

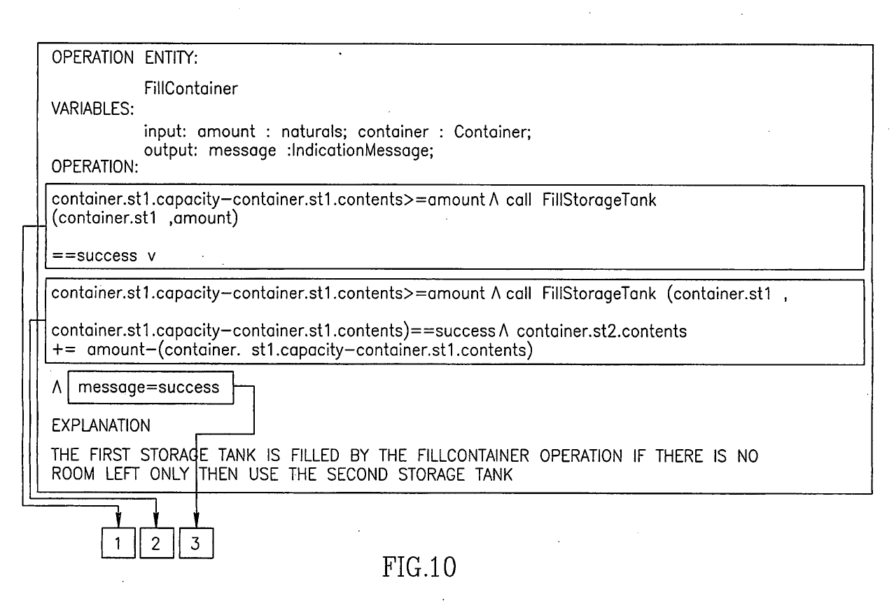

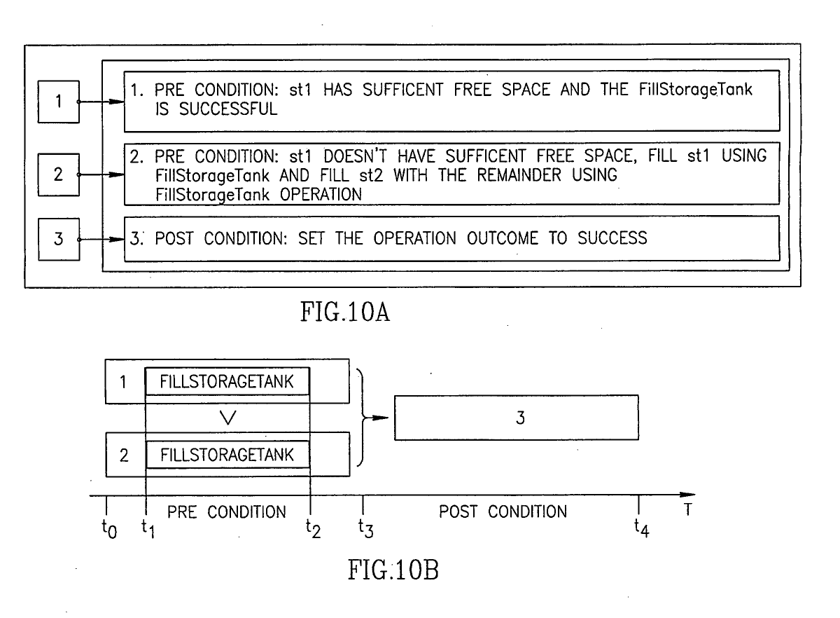

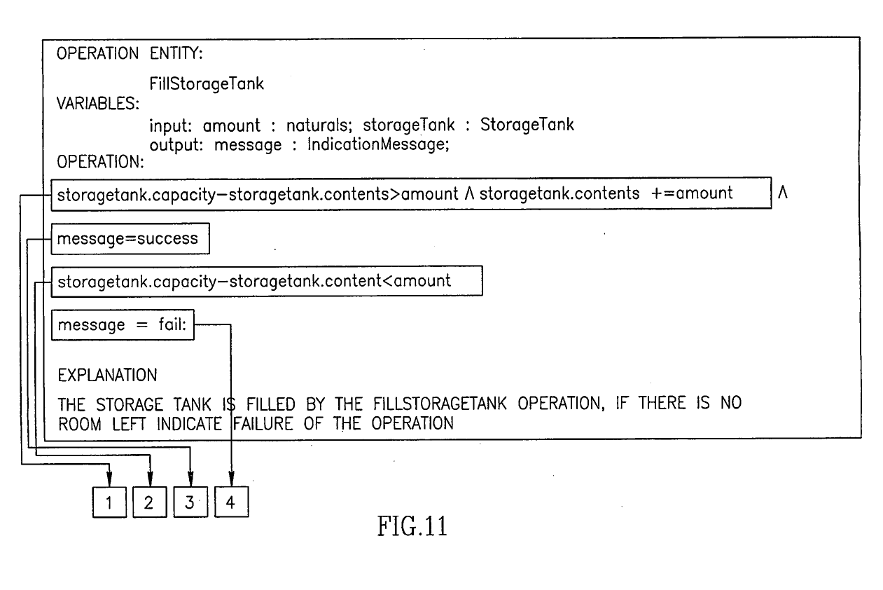

Reference is now made to FIGS. 10 through 14 which are block diagrams of exemplary operation entities. Each figure contains the following: the logical operation, marked with the figure number, an explanation of the logical operation divided to pre and post condition, marked with the figure number and the identifier “A”, and, a time line depicting the operation temporal execution, marked with the figure number and the identifier B.

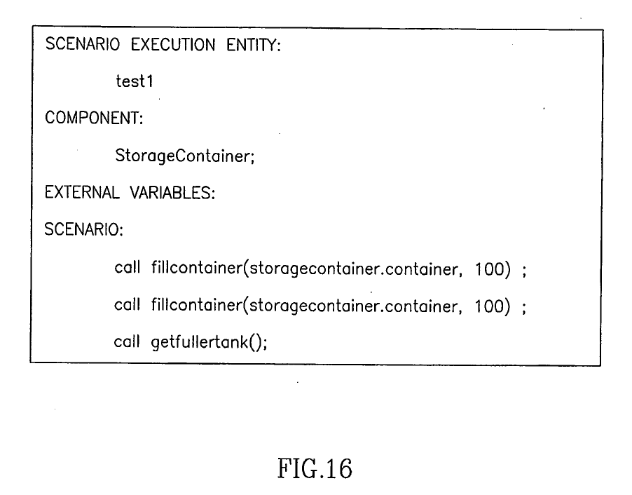

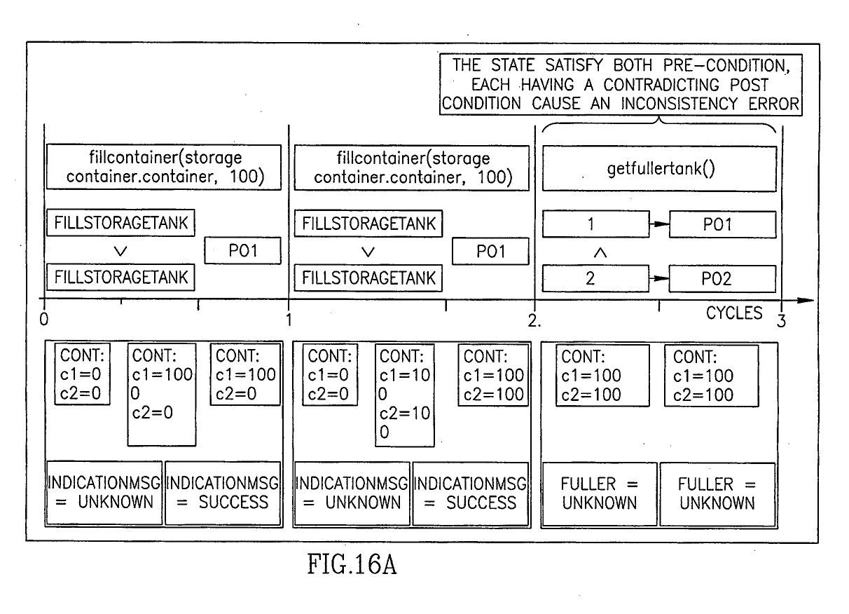

Reference is now made to FIGS. 16 through 18A which are block diagrams of three exemplary scenario execution entities demonstrating various failures of the specification requirements of the exemplary system described in FIG. 4 in accordance with some embodiments of the present invention, and graphs describing the exemplary scenario execution entities. It should be noted that in accordance with some embodiments of the present invention, the scenario execution entities may be used to test and verify the requirements specification.

A scenario execution entity may be used to simulate the execution of the specified system. A scenario execution entity may include a component definition statement and an external object definition statement. During simulation external objects may be required to invoke operations. Such external objects may be defined in the external object definition statement of the scenario execution entity. Furthermore, the scenario execution entity may include an execution scenario statement which may be, for example, a list of the statements used for the initialization of the external objects and the manipulation of the specified system.

As described above, the exemplary system of FIG. 4 and the entities above contain intentional errors to demonstrate testing and verification abilities of the embodiments of the present invention. It is assumed that a default specification model state was defined to handle each of the error states.

FIG. 16 is a block diagram of an exemplary scenario execution entity demonstrating an inconsistency error in accordance with some embodiments of the present invention. The scenario execution entity described in FIG. 16 may contain three logical statements spanning over three simulation cycles as shown in FIG. 16A which is a simplified graph describing an exemplary simulation sequence based on the scenario execution entity. Reference is also made to FIGS. 10, 11 and 14, as well as to their sub-figures, labeled with the identifiers “A” and “B”. The first logical statement may be an invocation call to the operation entity FillContainer. This operation entity may contain two invocation calls to the FillStorageTank operation entity. The second logical statement is identical to the first and executed in the next cycle. At this point the two requests to FillContainer may set both StorageTank data entities in the container data entity to their limit of 100. The next logical statement may contain an invocation call to the GetFullerTank operation entity which may cause an inconsistency error as both pre-conditions of this entity are true, and their post-conditions express conflicting demands.

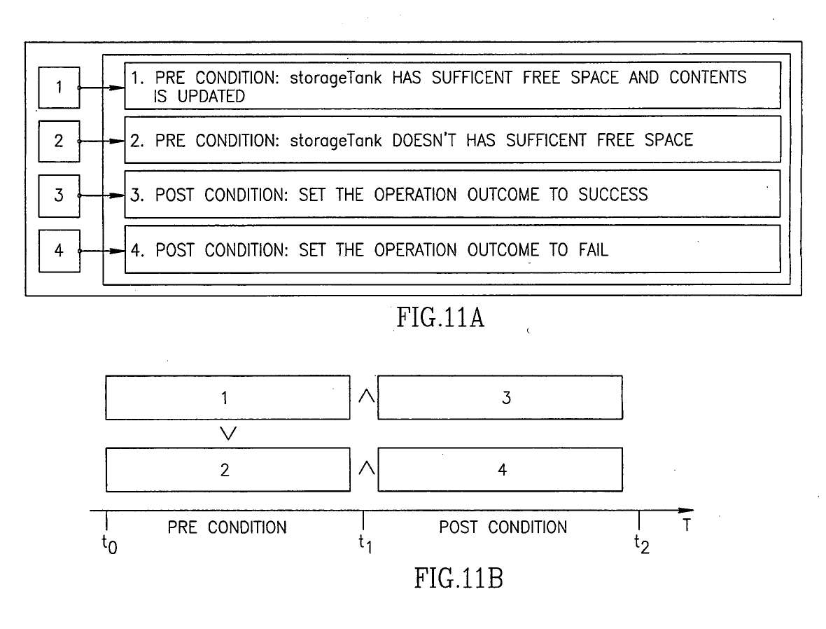

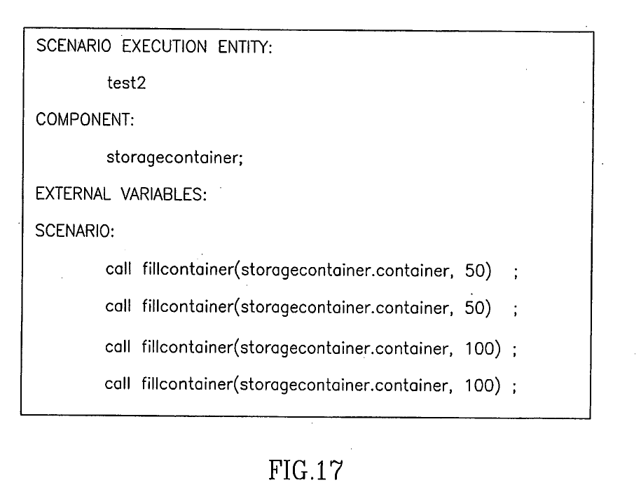

FIG. 17 is a block diagram of a second exemplary scenario execution entity demonstrating an incompleteness error and an invariant failure in accordance with some embodiments of the present invention. The scenario execution entity may contain four logical statements spanning over four simulation cycles as shown in FIG. 17A which is a simplified graph describing an exemplary simulation sequence based on the scenario execution entity. Reference is also made to FIGS. 10 and 11, as well as to their sub-figures, labeled with the identifiers “A” and “B”. The first logical statement may be an invocation call to the operation entity FillContainer. The second logical statement may be identical to the first and executed in the next cycle. The second FillContainer invocation call may cause an incompleteness error as the FillStorageTank operation entity fails to describe a pre-condition in which the amount to be filled equals the free space. The third logical statement may be another invocation call to FillContainer that may set both storage Tanks in the container to their limit of 100. The next invocation call to FillContainer operation, may cause the FillContainer operation to fill the second storage tank not according to the defined pre-condition, since the FillContainer operation failed to use the interface requirement defined by FillStorageTank and therefore fails to handle cases in which the amount to fill is over the capacity of the container. When simulating such requests the invariant at StorageTank may fail.

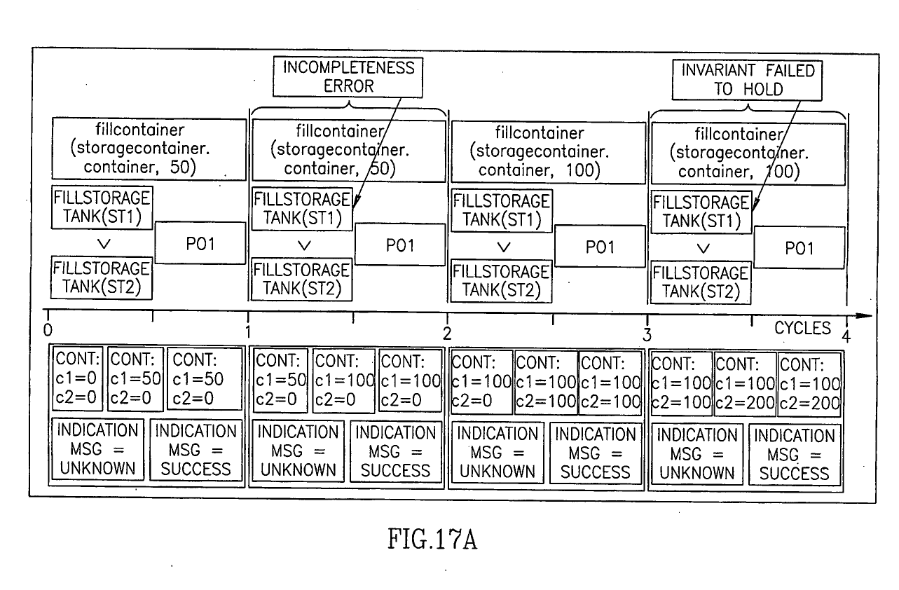

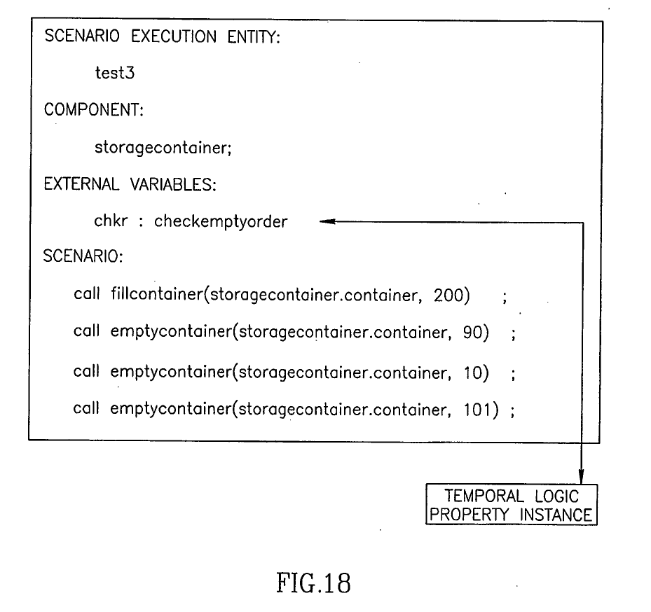

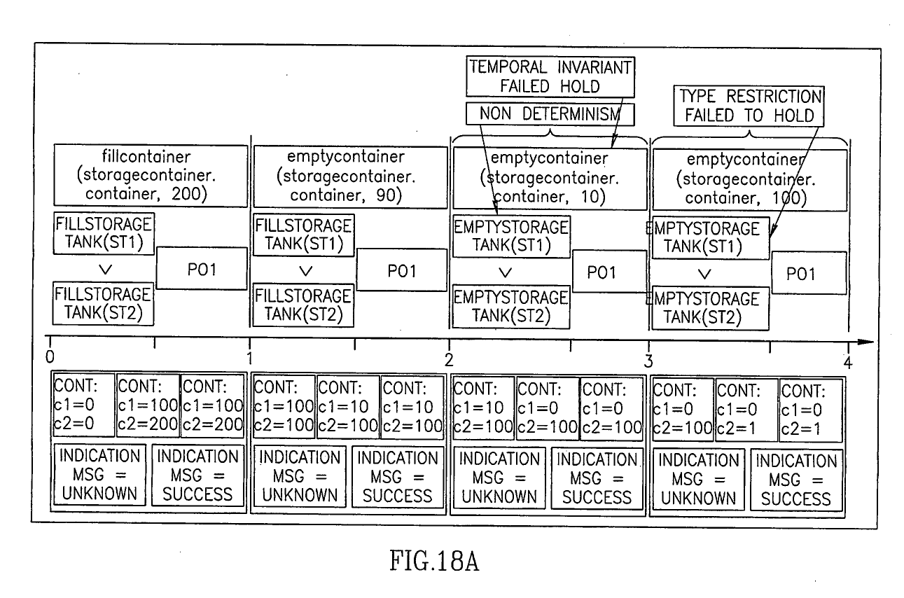

FIG. 18 is a block diagram of a third exemplary scenario execution entity demonstrating a temporal invariant failure, a failure of type restrictions, and a non-deterministic error in accordance with some embodiments of the present invention. This scenario execution entity may contain four logical statements spanning over four simulation cycles as described in FIG. 18A which is a simplified graph describing an exemplary simulation sequence based on the scenario execution entity. Reference is also made to FIGS. 10, 11, 12, 13 and 15, as well as to their sub-figures, labeled with the identifiers “A” and “B”. The first logical statement may be an invocation call to the operation entity FillContainer. The operation entity FillContainer may fill both storage tanks to their limit. The second and third logical statements may be two consecutive invocation calls to the EmptyContianer operation entity. These operation entities may cause the temporal invariant to fail, as the first storage tank may be emptied and not the one which currently contains more contents, as required by the temporal logic entity. This is an example of a possible mismatch between user requirements and the way requirements may be understood. The third invocation may cause a non-determinism error as the behavior of the specified system is non-deterministic in that in the EmptyStorageTank operation entity, the amount to be emptied equals the contents of the StorageTank. The fourth may cause another problem, as EmptyStorageTank operation entity does not contain a pre-condition handling cases in which the amount to be emptied is greater then the contents of the container. This may result in one of the storage tanks to have negative contents. However the contents variable is of type naturals, thus contradicting the constraint that the value of this variable can never be less than zero.

### Architecture of the Present Invention

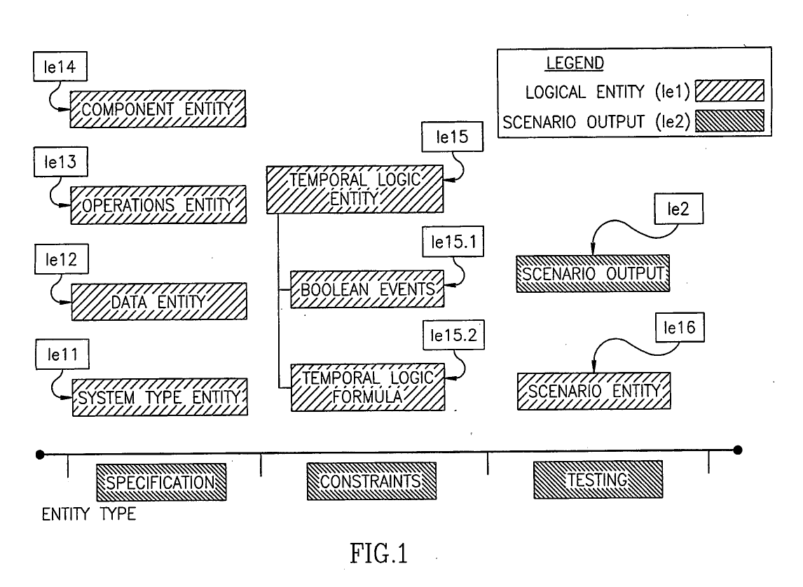

Reference now made to FIG. 20 which is a schematic block diagram of an exemplary System 1000 for testing and verification of system specifications requirements in accordance with some embodiments of the present invention. Reference is also made to FIG. 1 which is a schematic description of exemplary entities comprising the architecture of the invention. System 1000 may include a Requirements Modeling and Testing Component (RMTC) 1100, which may be used for creating and testing requirements specification. In addition, System 1000 may include a Main Repository (MR) 1200 that may be used for storing specification models, rules and tests. It should be noted the MR 1200 may be an auxiliary component to system 1000. Access to MR 1200 may be done through Repository Managers (RM) 1110. The RMTC 1100 may include a Requirements Static Modeling and Testing Component (RSMTC) 1130 for creating specifications as will be described below in details, and a Requirements Dynamic Testing Component (RDTC) 1120 for testing the specifications by simulation.

RSMTC 1130 may be designed to build and perform the static testing of the specification model. As shown in FIG. 20, users may create specification models in either a high-level specification language or in REL, which may be used as input 2000 to RSMTC 1130.

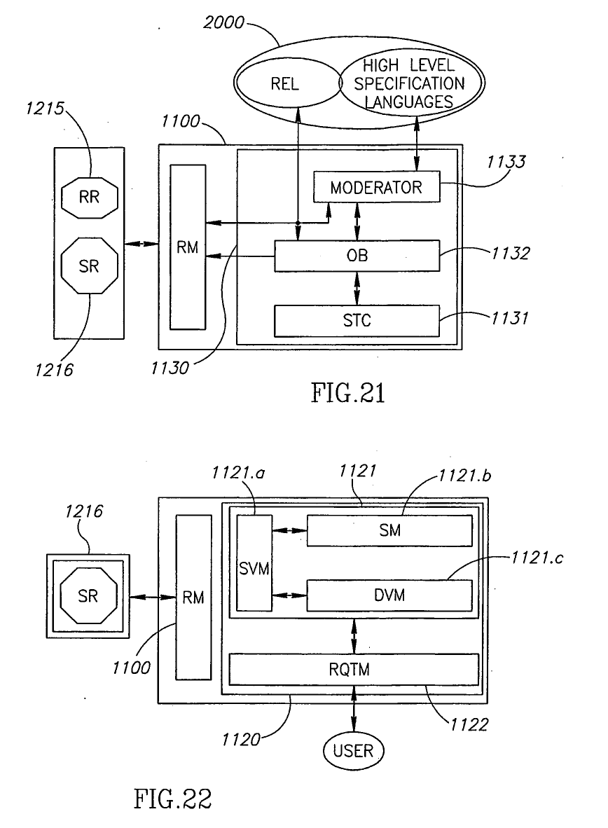

Reference is now made to FIG. 21 which is a schematic block diagram of an exemplary Requirements Static Modeling and Testing Component (RSMTC) 1130 in accordance with some embodiments of the present invention. RSMTC 1130 may include a Moderator 1133 that may moderate or translate the specification model if it is written in a high-level specification language. The Moderator 1133 may perform this operation based on language-specific rules stored in a Rule Repository (RR) 1215 which may be an internal component of MR 1200. The RSMTC 1130 may build a unique representation of the specification model, one which may support dynamic testing as will be described in details below. The unique representation of the specification model may be built by using an Object Builder (OB) 1132. Each object may then be validated by a Static Checker Component (STC) 1131. The STC 1131 may perform syntax checking and type checking. The statically-checked specification model may then be stored in a Specification Repository (SR) 1216 which may be an internal component of MR 1200. Users may use the RSMTC 1130 to create and build scenario execution entities for dynamic testing. Building a unique binary representation of scenario execution entities may be done using OB 1132. Such entities may be validated by an STC 1131, and may be used by the RDTC 1120 in simulation-based testing.

Reference is now made to FIG. 22 which is a schematic block diagram of an exemplary Requirements Dynamic Testing Component (RDTC) 1120 in accordance with some embodiments of the present invention. RDTC 1120 may perform a set of simulation-based tests on the specification model. Users may utilize the RDTC 1120 through a Requirements Tests Manager (RQTM) 1122. RQTM 1122 may be a sub-component of RDTC 1120 that may enable users to define and edit scenario execution entities, execute them and analyze test results. Users may load scenario execution entities from an SR 1216, or they may create new scenario entities. After a scenario is created, users may use RQTM 1122 to execute it, as described in details to follow. RDTC 1120 may include a Dynamic Testing Component (DTC) 1121. DTC 1121 may be composed of a Simulator Manager (SM) 1121.b, which may coordinate the simulation sequence. DTC 1121 may further include a Dynamic Verification Manager (DVM) 1121.c, which may be designed to activate different checkers during simulation. A checker may be a sub-component of DVM 1121.c that tests the specification model to be consistent, complete or deterministic. A unique checker may be designed for each test. A Simulation and Verification Manager (SVM) 1121.a may control the process of the dynamic testing. SVM 1121.a may be a sub-component of DTC 1121. Using RM 1110, SVM 1121.a may load the relevant component and scenario execution entities from SR 1216. Objects loaded from SR 1216 may already be in their simulation-ready format, due to a process that may be done in advance in the static stage by RSMTC 1130. SVM 1121.a may analyze the scenario execution entities, initiate the SM 1121.b accordingly, and may load the relevant checkers for the DVM 1121.b.

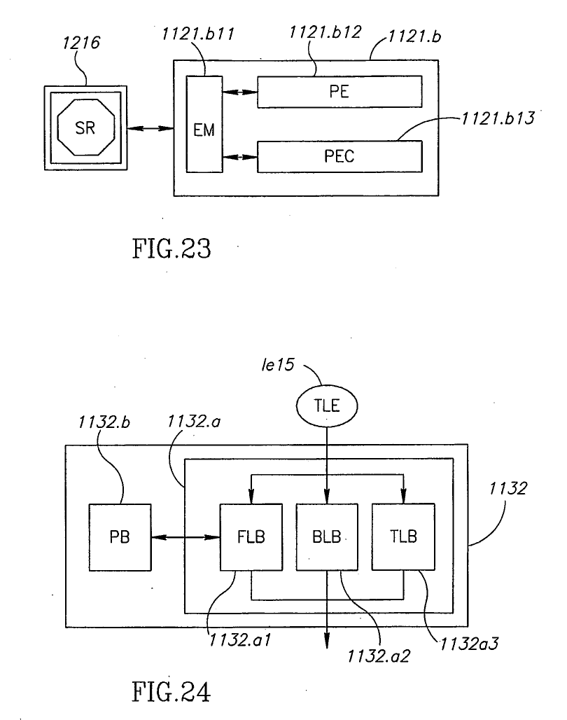

Reference is now made to FIG. 23 which is a schematic block diagram of an exemplary Dynamic Testing Component (DTC) 1121 in accordance with some embodiments of the present invention. To execute scenarios, SM 1121.b may use Predicate Evaluation Environment (PEE) 1121.b which may be part of DTC 1121. This PEE may provide the infrastructure required executing the scenarios according to the REL dynamic and temporal semantics described above. Each predicate defined in the scenario may be evaluated by a Predicate Evaluator (PE) 1121.b12. Since there may be several PE 1121.b12 running in parallel, in accordance with the semantics of REL, a single Predicate Evaluation Context (PEC) 1121.b13 may manage their execution. Predicates may be written in REL, and may be analyzed by the RSMTC 1130. Therefore, they may be ready for simulation when they are evaluated by PE 1211.b12. The SVM 1121.a may assign values to each data entity related to the scenario. These values may change during the evaluation of the predicates, being the essence of simulation.

When several PE 1121.b12 in a PEC are evaluated, the outcome of their evaluation may be checked to be consistent, complete and deterministic. In addition, invariant preservation may be verified by the DVM 1121.c, as described above, by specific checkers. When an error is detected by a checker, it may be reported to RQTM 1122. The reporting of the possibly detected errors may be done at different time granularities, depending on user preferences. A time granularity may be, for example, after each predicate in the scenario execution entity has been evaluated.

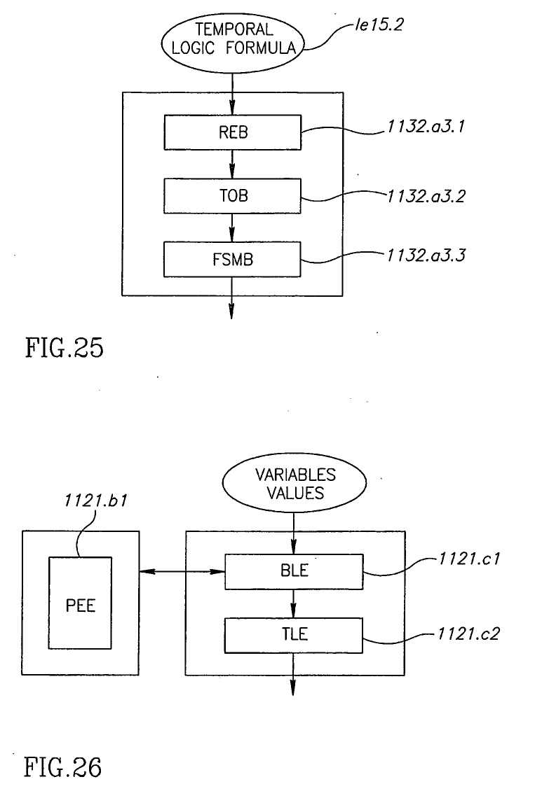

Reference is now made to FIGS. 24 and 25 which are flow chart illustrations of a method of building a checker, operative in accordance with some embodiments of the present invention. A checker may be built to analyze Temporal Logic Entity (TLE) le15 preservation. Preservation may be defined as the operation of a checker to verify which value a TLE le15 holds in each step of the simulation. A checker may analyze a TLE le15 after the TLE le15 is represented in REL format.

TLE le15 may be built, or transformed into REL format, by the RSMTC 1130, during the static stage of the verification. The RSMTC 1130 may use an OB 1132 (shown in FIG. 21), which may receive as input a TLE le15. TLE le15 may be built from both a Temporal Logic Formula le15.2 and a Boolean Event definition le15.1. A sub-component of the OB 1132, a Temporal Entity Object Builder (TEOB) 1132.a3, may receive the TLE le15.

The TEOB 1132.a3 may divide the TLE le15 into the components it may be built from, and each component may be sent to an appropriate builder. Boolean events may be divided into Boolean Event identifiers and First Order Logic description, which may be a REL predicate. A Predicate Builder (PB) 1132.b may build the internal object representation of the predicate, like any other predicate. A Boolean. Layer Builder (BLB) 1132.a2 may map the relation between the temporal layer Boolean atoms and their interpretation in terms of specification variables values and assertions.

As shown in FIG. 25, after a TLE le 15 is represented in REL format, a checker may be built to test its preservation during simulation. A checker may be, for example, a unique Finite State Machine (FSM) for a specific TLE le15. First, TLE le15 may be converted to a regular expression, using a Regular Expression Builder (REB) 1132.a3.1. Next, temporal operators which cannot be expressed as regular expressions may be converted in a Temporal Operator Builder (TOB) 1132.a3.2 into an internal representation. Finally, the regular expression and the temporal operators may serve as input to the Finite State Machine Builder (FSMB) 1132.a3.3 and a corresponding FSM may be built.

Reference is now made to FIGS. 23 and 26 which are a schematic block diagram of an exemplary Simulator Manager in accordance with some embodiments of the present invention, and a schematic block diagram of an exemplary Dynamic Verification Manager (DVM) 1121.c in accordance with some embodiments of the present invention. DVM 1121.c may receive data entities le12 values as input during simulation, and it may test if the temporal formula lel5.2 for these data entities holds a true value. This test may take place in two stages. First, a Boolean Layer Evaluator (BLE) 1121.c1 may assign true values to the Boolean events of the temporal formula entity. The BLE 1121.c1 may use a Predicate Evaluation Environment (PEE) 1121.b1 for this aim. Each Boolean event may be a REL predicate, and may therefore be evaluated by a PEC 1121.b3. The Boolean outcome of the evaluation may be assigned to the corresponding Boolean event. The second stage may be done by a Temporal Layer Evaluator (TLE) 1121.c2. According to the values of each of the Boolean events comprising the Temporal Formula, a final Boolean outcome may be calculated, and transferred as input to each of the specific checkers so that they may analyze their TEL le15 entities.

It will be appreciated that the present invention is not limited by what has been described hereinabove and that numerous modifications, all of which fall within the scope of the present invention, exist. For example, while the present invention has been described with respect to the description of the system requirements specifications may be written in REL, it may be written in another formal language.

It will be appreciated by persons skilled in the art that the present invention is not limited by what has been particularly shown and described herein above. Rather the scope of the invention is defined by the claims which follow:

1. A method for testing and verifying a requirements specification of a system, comprising:
describing said requirements specification in a REQUIREMENTS ENGINEERING LANGUAGE (REL);
simulating an execution of a scenario of said REL; and
identifying logical faults in said requirements specification based on said simulating.

2. The method of claim 1, wherein said describing further comprises separating said requirements specification into at least one entity to express a characteristic of said requirements specification.

3. The method of claim 2, wherein said separating said requirements specification into said at least one entity further comprises defining at least one type of a variable in said requirements specification.

4. The method of claim 3, wherein said separating said requirements specification into said at least one entity further comprises defining at least one entity to contain said at least one type of variable.

5. The method of claim 4, wherein said step of defining further comprises expressing at least of one constraint on said at least one type entity.

6. The method of claim 2, wherein said separating said requirements specification into said at least one entity further comprises defining a possible manipulation of said at least one entity during said simulating.

7. The method of claim 6, wherein said possible manipulation is defined by an input variable.

8. The method of claim 6, wherein said possible manipulation is defined by at least one condition that is required to exist for said possible manipulation to be done.

9. The method of claim 6, wherein said manipulation is done in parallel during said simulating.

10. The method of claim 6, wherein said manipulation is done sequentially during said simulating.

11. The method of claim 2, wherein said separating said requirements specification into said at least one entity further comprises defining an entity to describe said system.

12. The method of claim 2, wherein said separating said requirements specification into said at least one entity further comprises defining at least one temporal restriction imposed on said system.

13. The method of claim 12, wherein said defining at least one temporal restriction imposed on said system further comprises describing a behavior of said system over at least one cycle of said simulating.

14. The method of claim 13, wherein said defining at least one temporal restriction imposed on said system further comprises defining a possible event that may effect said system.

15. The method of claim 2, wherein said separating said requirements specification into said at least one entity further comprises defining a scenario to be simulated during said simulating.

16. The method of claim 1, wherein said simulating further comprises checking said requirements specification to be logical.

17. The method of claim 16, wherein said checking further comprises checking for no conflicting requirements.

18. The method of claim 16, wherein said checking further comprises checking for no more than one possible outcome for an operation to be simulated or for a value of said at least one entity.

19. The method of claim 16, wherein said checking further comprises checking for an outcome for said operation to be simulated or for said value of said at least one entity.

20. The method of claim 16, wherein said checking further comprises checking at least one restriction defined by a user of said system.

21. A system for testing and verifying of requirements specification of a system, comprising:
a modeling and testing component to build a model of said requirements specification; and
a dynamic testing component to test said requirements specification by execution of at least one simulation cycle.

22. The system of claim 21 further comprising a main repository component to store said model of said requirements specification.

23. The system of claim 22 wherein said main repository component is auxiliary to said system.

24. The system of claim 21, wherein said modeling and testing component performs at least one static test to said model of said requirements specification.

25. The system of claim 21 wherein said modeling and testing component translates a high-level specification language to said requirements engineering language.

26. The system of claim 21 wherein said modeling and testing component receives said requirements engineering language.

27. The system of claim 21, wherein said modeling and testing component further comprises:
a moderator component to translate said high-level specification to said requirements engineering language;
an object builder component to build a unique representation of said specification requirements; and
a checker component to check characteristics of said unique representation.

28. The system of claim 22 wherein said main repository further comprises a rule repository component to store syntax rules of said high-level specification language.

29. The system of claim 22 wherein said main repository further comprises a specification repository component to store said specification requirements after said checker component checks it.

30. The system of claim 21, wherein said dynamic testing component further comprises:
a requirements tests manager to define, simulate, and analyze a scenario;
a simulator manager to coordinate the simulation sequence of said scenario;
a dynamic verification manager to activate said checkers during said simulation sequence; and
a simulation and verification manager to control said dynamic testing component.

31. The system of claim 30, wherein said simulation and verification manager is further adapted to load at least one entity for simulation from said specification repository component.

32. The system of claim 31, wherein said at least one entity can be simulated substantially immediately.

33. The system of claim 30, wherein said simulation and verification manager is further adapted to analyze said scenario.

34. The system of claim 30, wherein said simulation and verification manager is further adapted to initiate said simulator manager and load said checkers for said dynamic verification manager.

35. The system of claim 30, wherein said simulator manager further comprises:
an evaluation component to provide an infrastructure required to execute said scenario; and
an evaluation context component to control an execution of at least one evaluator of said scenario.

36. The system of claim 35, wherein said at least one evaluator is executed in parallel to at least a second evaluator.

37. The system of claim 35, wherein said evaluator is evaluating an entity written in said requirements engineering language.

38. The system of claim 35, further comprises an outcome repository to store the outcome of said execution of said at least one evaluator of said scenario.

39. The system of claim 30, wherein said dynamic verification manager is further adapted to receive values of said at least one entity during simulation.

40. The system of claim 30, wherein said dynamic verification manager is further adapted to check if said values are true values for said at least one entity within said simulation.

41. The system of claim 30, wherein said dynamic verification manager is further adapted to detect an error of said execution by said at least one evaluator of said scenario.

42. The system of claim 27, wherein said object builder further comprises:
a temporal entity object builder to receive a temporal logic entity from said modeling and testing component,
wherein said temporal entity object builder is adapted to divide said temporal logic entity to at least one component said temporal logic entity is built from; and
wherein said at least one component is sent to a builder within said object builder.

43. A modeling and testing apparatus comprising:
a moderator component to translate a high-level specification requirements to a REQUIREMENTS ENGINEERING LANGUAGE (REL);
an object builder component to build a unique representation of said specification requirements; and
a checker component to check characteristics of said unique representation.

44. The modeling and testing apparatus of claim 43, wherein said object builder further comprises:
a temporal entity object builder to receive a temporal logic entity from said modeling and testing component,
wherein said temporal entity object builder is adapted to divide said temporal logic entity to at least one component said temporal logic entity is built from; and
wherein said at least one component is sent to a builder within said object builder.

45. A dynamic testing apparatus comprising:
a requirements tests manager to define, simulate, and analyze a scenario;
a simulator manager to coordinate the simulation sequence of said scenario;
a dynamic verification manager to activate said checkers during said simulation sequence; and
a simulation and verification manager to control said dynamic testing component.

46. The dynamic testing apparatus of claim 45, wherein said simulation and verification manager is further adapted to load at least one entity for simulation from said specification repository component.

47. The dynamic testing apparatus of claim 46, wherein said at least one entity can be simulated substantially immediately.

48. The dynamic testing apparatus of claim 45, wherein said simulation and verification manager is further adapted to analyze said scenario.

49. The dynamic testing apparatus of claim 45, wherein said simulation and verification manager is further adapted to initiate said simulator manager and load said checkers for said dynamic verification manager.

50. The dynamic testing apparatus of claim 45, wherein said simulator manager further comprises:
an evaluation component to provide an infrastructure required to execute said scenario; and
an evaluation context component to control an execution of at least one evaluator of said scenario.

51. The dynamic testing apparatus of claim 48, wherein said at least one evaluator is executed in parallel to at least a second evaluator.

52. The dynamic testing apparatus of claim 48, wherein said evaluator evaluates said at least one entity written in said requirements engineering language.

53. The dynamic testing apparatus of claim 48, further comprises an outcome repository to store the outcome of said execution of said at least one evaluator of said scenario.

54. The dynamic testing apparatus of claim 45, wherein said dynamic verification manager is further adapted to detect an error of said execution by said at least one evaluator of said scenario.

55. The dynamic testing apparatus of claim 45, wherein said dynamic verification manager is further adapted to receive values of said at least one entity during simulation.

56. The dynamic testing apparatus of claim 45, wherein said dynamic verification manager is further adapted to check if said values are true values for said simulation.

57. The dynamic testing apparatus of claim 45, wherein said dynamic verification manager is further adapted to detect an error of said execution by said at least one evaluator of said scenario.
